(19) United States
(12) Patent Application Publication
(10) Pub. No.: US 2022/0107528 A1
(43) Pub. Date: Apr. 7, 2022

(54) LIQUID CRYSTAL DISPLAY PANEL AND MANUFACTURING METHOD THEREOF

(71) Applicant: SHENZHEN CHINA STAR OPTOELECTRONICS SEMICONDUCTOR DISPLAY TECHINOLOGY CO., LTD., Shenzhen, Guangdong (CN)

(72) Inventor: Macai LU, Shenzhen (CN)

(21) Appl. No.: 16/764,221

(22) PCT Filed: Apr. 14, 2020
(86) PCT No.: PCT/CN2020/084747

§ 371 Date: May 14, 2020

(30) Foreign Application Priority Data
Apr. 2, 2020 (CN) 202010254220.2

(51) Int. Cl. G02F 1/1335; G02F 1/1334; G02F 1/1368; G02F 1/1343; G02F 1/1341

(52) U.S. Cl. CPC G02F 1/133516; G02F 1/13345; G02F 1/1368; G02F 2201/50; G02F 1/13439; G02F 1/1341; G02F 1/133512

(57) ABSTRACT

A liquid crystal display panel and a manufacturing method thereof are provided. The liquid crystal display panel includes a first substrate provided with a first color resist layer, a second substrate disposed correspondingly to the first substrate and provided with a second color resist layer, and a polymer network liquid crystal layer. Wherein, the first color resist layer includes a plurality of first sub-color resists, and the second color resist layer includes a plurality of second sub-color resists disposed correspondingly to the first sub-color resists according to colors and positions.

### FIELD OF INVENTION

The present disclosure relates to the field of display technologies, and more particularly, to a liquid crystal display panel and a manufacturing method thereof.

### BACKGROUND OF INVENTION

With development of display technologies, various new technologies continue to emerge and enrich various new display application scenarios. Wherein, transparent displays can be used in fields of cargo display cabinets, electronic bulletin boards, and heads-up displays, and have received widespread attention. Presently, there are two main technical routes to achieve transparent display. One is conventional liquid crystal display panels, and a light transmittance thereof can be improved by a design of red, green, blue, and white pixels, but the light transmittance is still lower (less than 20%). The other one uses active lighting technology such as OLEDs. This technology has a higher light transmittance, but defects in contrast and brightness greatly limit its application.

Based on this, polymer network liquid crystal (PNLC) displays have come into being, liquid crystal materials used thereof are significantly different from ordinary liquid crystal materials, and the polymer network liquid crystal display is a liquid crystal polymer composite material. In polymer network liquid crystals, polymers are distributed in liquid crystals in a network structure, while the liquid crystals exist in a continuous phase form. When refractive indexes of the liquid crystals and the polymers do not match, strong scattering occurs and an opaque state appears, while when the refractive indexes of the two match, a transparent state appears. Therefore, the light transmittance can be controlled by applying an electric field to the PNLCs, so that they are widely used in new types of displays, such as smart windows. However, in current PNLC displays, there is still a problem of low contrast.

Technical problem: the present disclosure provides a liquid crystal display panel and a manufacturing method thereof. The flexible display panel can effectively improve dark-state light leakage and the problem of low contrast.

### SUMMARY OF INVENTION

To solve the above problems, in one aspect, an embodiment of the present disclosure provides a liquid crystal display panel. The liquid crystal display panel comprises:

a first substrate provided with a first color resist layer;

a second substrate disposed correspondingly to the first substrate and provided with a second color resist layer; and

a polymer network liquid crystal layer disposed between the first substrate and the second substrate;

wherein the first color resist layer comprises a plurality of first sub-color resists, and the second color resist layer comprises a plurality of second sub-color resists disposed correspondingly to the first sub-color resists in the first color resist layer according to colors and positions.

In the liquid crystal display panel provided by an embodiment of the present disclosure, colors of any adjacent two of the first sub-color resists are different.

In the liquid crystal display panel provided by an embodiment of the present disclosure, the first color resist layer is disposed on one side of the first substrate adjacent to the polymer network liquid crystal layer, and the second color resist layer is disposed on one side of the second substrate facing away from the polymer network liquid crystal layer.

In the liquid crystal display panel provided by an embodiment of the present disclosure, the first sub-color resists in the first color resist layer are arranged at intervals, and the second sub-color resists in the second color resist layer are arranged adjacently.

In the liquid crystal display panel provided by an embodiment of the present disclosure, an area of the second sub-color resists is 5% to 15% greater than an area of the corresponding first sub-color resists.

In the liquid crystal display panel provided by an embodiment of the present disclosure, an orthographic projection of any one of the first sub-color resists on the first substrate is within an orthographic projection area of the corresponding second sub-color resist on the first substrate.

In the liquid crystal display panel provided by an embodiment of the present disclosure, the first sub-color resists comprise a plurality of first red sub-color resists, a plurality of first green sub-color resists, and a plurality of first blue sub-color resists.

In the liquid crystal display panel provided by an embodiment of the present disclosure, the first sub-color resists comprise a plurality of first red sub-color resists, a plurality of first green sub-color resists, a plurality of first blue sub-color resists, and a plurality of first white sub-color resists.

In the liquid crystal display panel provided by an embodiment of the present disclosure, a number of the first white sub-color resists accounts for 25% or 50% of a total number of the first sub-color resists.

In the liquid crystal display panel provided by an embodiment of the present disclosure, on one side surface of the second substrate facing away from the polymer network liquid crystal layer, the second color resist layer and a protective layer are stacked in sequence.

In the liquid crystal display panel provided by an embodiment of the present disclosure, the protective layer is a transparent organic polymer thin film or a silicon nitride thin film.

In the liquid crystal display panel provided by an embodiment of the present disclosure, on one side of the first substrate adjacent to the polymer network liquid crystal layer, a thin film transistor layer, the first color resist layer, a pixel electrode layer, and a first alignment film are stacked in sequence.

In the liquid crystal display panel provided by an embodiment of the present disclosure, on one side surface of the second substrate adjacent to the polymer network liquid crystal layer, a black matrix layer, a common electrode layer, and a second alignment film are stacked in sequence.

For another aspect, an embodiment of the present disclosure further provides a manufacturing method of liquid crystal display panel. The manufacturing method comprises following steps:

S01: providing a first substrate and forming a thin film transistor layer, a first color resist layer, a pixel electrode layer, and a first alignment film on the first substrate in sequence, wherein the first color resist layer comprises a plurality of first sub-color resists;

S02: providing a second substrate and forming a second color resist layer and a protective layer on a first surface of the second substrate in sequence, wherein the second color resist layer comprises a plurality of second sub-color resists disposed correspondingly to the first sub-color resists in the first color resist layer;

S03: flipping the second substrate and forming a black matrix layer, a common electrode layer, a second alignment film, and a spacer layer on a second surface of the second substrate in sequence;

S04: aligning the first substrate to the second surface of the second substrate to form a cell; and

S05: forming a polymer network liquid crystal layer between the first substrate and the second substrate.

In the manufacturing method of the liquid crystal display panel provided by an embodiment of the present disclosure, in the step S02, a step of forming the protective layer comprises forming a layer of transparent organic polymer thin film by coating or forming a layer of silicon nitride thin film by chemical vapor deposition.

In the manufacturing method of the liquid crystal display panel provided by an embodiment of the present disclosure, the first sub-color resists in the first color resist layer are arranged at intervals, and the second sub-color resists in the second color resist layer are arranged adjacently.

In the manufacturing method of the liquid crystal display panel provided by an embodiment of the present disclosure, an orthographic projection of any one of the first sub-color resists on the first substrate is within an orthographic projection area of the corresponding second sub-color resist on the first substrate.

Beneficial effect: compared to current technology, the present disclosure provides a polymer network liquid crystal display panel through disposing color filters on both a first substrate and a second substrate, wherein two layers of color filters are disposed correspondingly. When polymer network liquid crystals are in a scattering mode, an extent of dark-state light leakage can be reduced by using an absorption effect of the color filters having different colors in adjacent sub-pixels on scattered light from adjacent pixels thereof. For example, when each sub-pixel is on a dark state (a scattering state), scattered light thereof will be absorbed by adjacent sub-pixels having different colors of color filters, thereby reducing the scattered light to transmit through a front glass substrate, that is, reducing dark-state light leakage and improving contrast.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic cross-sectional structural diagram of a liquid crystal display panel in current technology.

FIG. 2 is a schematic cross-sectional structural diagram of a liquid crystal display panel according to an embodiment of the present disclosure.

FIGS. 3A to 3D are schematic structural process diagrams of a manufacturing method of a liquid crystal display panel according to an embodiment of the present disclosure.

### DETAILED DESCRIPTION OF PREFERRED EMBODIMENTS

The embodiments of the present disclosure are described in detail hereinafter. Examples of the described embodiments are given in the accompanying drawings. The specific embodiments described with reference to the attached drawings are all exemplary and are intended to illustrate and interpret the present disclosure. Based on the embodiments in the present disclosure, all other embodiments obtained by those skilled in the art without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or implicitly indicating the number of technical features indicated. Thus, features limited by “first” and “second” are intended to indicate or imply including one or more than one these features. In the description of the present disclosure, “a plurality of” relates to two or more than two, unless otherwise specified.

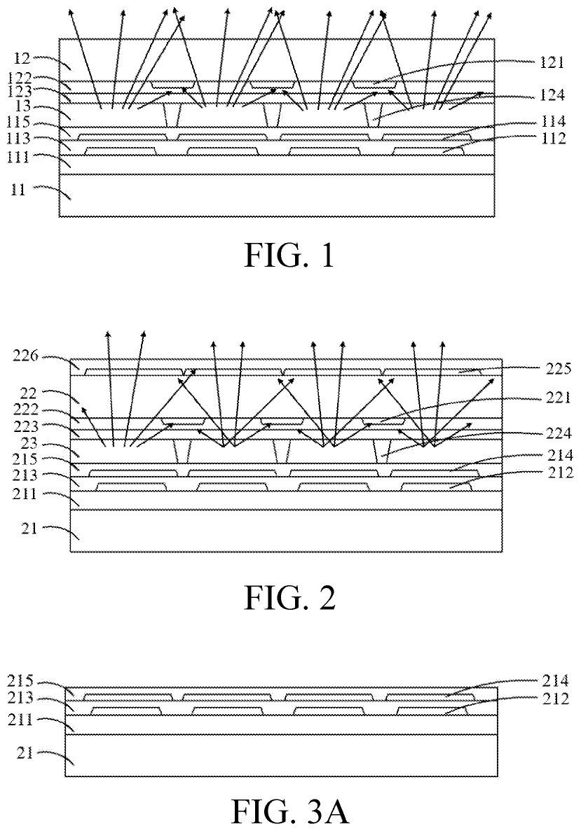

Polymer network liquid crystal displays, due to their special display mode, have been widely used in emerging display modes such as smart windows. Please refer to FIG. 1, a schematic structural diagram of cross-sectional film layers of a conventional polymer network liquid crystal display panel in current technology is provided. Specifically, the conventional polymer network liquid crystal display panel comprises:

a first substrate 11 provided with a thin film transistor layer 111, a color resist layer 112, an insulating layer 113, a pixel electrode layer 114, and a first alignment film 115 in sequence;

a second substrate 12 provided with a black matrix layer 121, a common electrode layer 122, a second alignment film 123, and a spacer layer 124 in sequence; and

a polymer network liquid crystal layer 13 disposed between manufactured first substrate 11 and second substrate 12.

In polymer network liquid crystals, when it is not powered, light appears in a scattered state, and other than a part of light shielded by the black matrix layer, most of the light leaks out, causing a serious phenomenon of dark-state light leakage, thereby resulting in lower contrast.

Based on this, in order to improve the dark-state light leakage phenomenon, an embodiment of the present disclosure provides a display panel. A cross-sectional structure of the display panel can be referred to FIG. 2. The display panel comprises:

a first substrate 21 provided with a first color resist layer 212;

a second substrate 22 disposed correspondingly to the first substrate 21 and provided with a second color resist layer 225; and

a polymer network liquid crystal layer 23 disposed between the first substrate 21 and the second substrate 22;

wherein, the first color resist layer 212 comprises a plurality of first sub-color resists, and the second color resist layer 225 comprises a plurality of second sub-color resists disposed correspondingly to the first sub-color resists in the first color resist layer 212 according to colors and positions. That is, a second sub-color resist having a same color is disposed on a corresponding position of one of the first sub-color resists in the first color resist layer 212. It should be noted that the corresponding position described herein refers to projections of any one of the first sub-color resists and the corresponding second sub-color resist on the first substrate 21 overlap or partially overlap.

In some embodiments, the first substrate is an array substrate, and the second substrate is a color filter substrate.

In some embodiments, in the plurality of first sub-color resists, any two adjacent first sub-color resists have different colors. Through this arrangement having different colors of color resists, in any one of sub-pixels, light emitted from a backlight will form light having a specific color after passing through the first color resist layer 212. When in a dark state, light in the pixel scatters toward all angles. Wherein, light scattered to adjacent sub-pixels will be filtered by the adjacent second color resist layer 225 having different colors, thereby reducing dark-state light leakage in a certain degree and improving contrast. It can be understood that because the second color resist layer 225 and the first color resist layer 212 are disposed correspondingly, the second color resist layer 225 has a same arrangement of sub-color resists, which is not repeated herein.

In some embodiments, the first color resist layer 212 is disposed on one side of the first substrate 21 adjacent to the polymer network liquid crystal layer 23, and the second color resist layer 225 is disposed on one side of the second substrate 22 facing away from the polymer network liquid crystal layer 23. Since the second substrate 22 has a certain thickness, by disposing the second color resist layer 225 on the side of the second substrate 22 facing away from the polymer network liquid crystal layer 23, that is, by disposing the second color resist layer 225 on an outer side of the second substrate 22 along a light-emitting direction, the second color resist layer 225 can be used to filter scattered light having larger angles when in a dark state, which also filters out a larger proportion of scattered light and further reduces the degree of dark-state light leakage.

In some embodiments, the first sub-color resists in the first color resist layer are disposed at intervals in sequence, and the second sub-color resists in the second color resist layer are disposed adjacently in sequence to obtain the second sub-color resists having a greater area to filter more scattered light when in a dark state. In an ordinary condition, an area of the second sub-color resists is 5% to 15% greater than an area of the corresponding first sub-color resists.

In some embodiments, an orthographic projection of any one of the first sub-color resists on the first substrate is within an orthographic projection area of the second sub-color resist corresponding to the first sub-color resist on the first substrate.

In some embodiments, the first sub-color resists comprise a plurality of first red sub-color resists, a plurality of first green sub-color resists, and a plurality of first blue sub-color resists.

In some embodiments, the first sub-color resists comprise a plurality of first red sub-color resists, a plurality of first green sub-color resists, a plurality of first blue sub-color resists, and a plurality of first white sub-color resists. Wherein, a number of the first white sub-color resists accounts for 25% or 50% of a total number of the first sub-color resists. For example, in a pixel, it is arranged according to R/G/B/W or R/W/G/W/B/W.

In some embodiments, on one side surface of the second substrate 22 facing away from the polymer network liquid crystal layer 23, the second color resist layer 225 and a protective layer 226 are stacked in sequence. Wherein, disposition of the protective layer 226 effectively prevents the second color resist layer 225 from being scratched, and the protective layer may usually be a transparent organic polymer thin film or a silicon nitride thin film.

In some embodiments, on one side of the first substrate 21 adjacent to the polymer network liquid crystal layer 23, a thin film transistor layer 211, the first color resist layer 212, an insulating layer 213, a pixel electrode layer 214, and a first alignment film 215 are stacked in sequence.

Wherein, the thin film transistor layer 211 comprises a plurality of thin film transistors arranged in an array, which usually comprises an active layer, a gate electrode, a source electrode, a drain electrode, and an interlayer insulating layer. Each of the thin film transistors is electrically connected to a corresponding pixel electrode in the pixel electrode layer 214 of an upper layer, one-to-one (which are not shown in the figure).

In some embodiments, on one side surface of the second substrate 22 adjacent to the polymer network liquid crystal layer 23, a black matrix layer 221, a common electrode layer 222, and a second alignment film 223 are stacked in sequence.

Wherein, the black matrix layer 221 comprises a plurality of black matrices disposed on corresponding positions of each spacing area of sub-pixels in the first color resist layer 212.

The common electrode layer 222 is usually an indium tin oxide film spread across an entire surface, and works together with the pixel electrode layer 214 to form an electric field to drive liquid crystals to deflect.

In some embodiments, the polymer network liquid crystal layer 23 further comprises a spacer layer 224. The spacer layer 224 comprises a plurality of support columns disposed in a non-pixel area and providing a stable space for the polymer network liquid crystal layer 23.

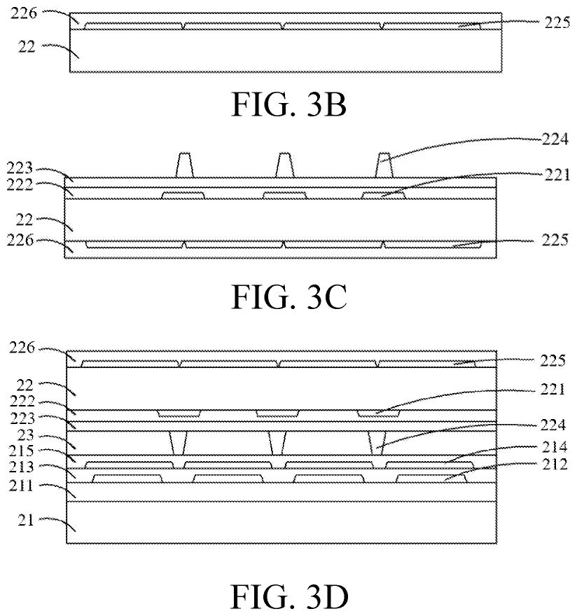

Referring to FIGS. 3A to 3D, an embodiment of the present disclosure further provides a manufacturing method of the above liquid crystal display panel. The method comprises following steps:

S01: providing the first substrate 21 and forming the thin film transistor layer 211, the first color resist layer 212, the insulating layer 213, the pixel electrode layer 214, and the first alignment film 215 on the first substrate 21 in sequence, wherein the first color resist layer 212 comprises a plurality of first sub-color resists, that is, forming a structure shown in FIG. 3A.

S02: providing the second substrate 22 and forming the second color resist layer 225 and the protective layer 226 on a first surface of the second substrate 22 in sequence, wherein the second color resist layer 225 comprises a plurality of second sub-color resists disposed correspondingly to the first sub-color resists in the first color resist layer 212, that is, forming a structure shown in FIG. 3B.

Wherein, a step of forming the protective layer 226 usually comprises forming a layer of transparent organic polymer thin film by coating or forming a layer of silicon nitride thin film by chemical vapor deposition.

S03: flipping the second substrate 22 and forming the black matrix layer 221, the common electrode layer 222, the second alignment film 223, and the spacer layer 224 on a second surface of the second substrate 22 in sequence, that is, forming a structure shown in FIG. 3C.

S04: aligning the first substrate 21 to the second surface of the second substrate 22 to form a cell.

S05: forming the polymer network liquid crystal layer 23 between the first substrate 21 and the second substrate 22. Specifically, the polymer network liquid crystal layer 23 is disposed between the first alignment film 215 and the second alignment film 223.

It can be understood that each of the above functional layers is formed respectively according to conventional processes in the field, which is not repeated herein.

It should be noted that the above embodiments of the liquid crystal display panel only describe the above structures. It can be understood that other than the above structures, the liquid crystal display panel provided by the embodiment of the present disclosure may also include any other necessary structures as needed, which is not specifically limited herein.

The liquid crystal display panel and the manufacturing method thereof provided by the embodiments of the present disclosure are described in detail above. Specific examples are used herein to explain the principles and implementation of the present disclosure. The descriptions of the above embodiments are only used to help understand the method of the present disclosure and its core ideas; meanwhile, for those skilled in the art, the range of specific implementation and application may be changed according to the ideas of the present disclosure. In summary, the content of the specification should not be construed as causing limitations to the present disclosure.

What is claimed is:

1. A liquid crystal display panel, comprising:
a first substrate provided with a first color resist layer;
a second substrate disposed correspondingly to the first substrate and provided with a second color resist layer; and
a polymer network liquid crystal layer disposed between the first substrate and the second substrate;
wherein the first color resist layer comprises a plurality of first sub-color resists, and the second color resist layer comprises a plurality of second sub-color resists disposed correspondingly to the first sub-color resists in the first color resist layer according to colors and positions.

2. The liquid crystal display panel according to claim 1, wherein colors of any adjacent two of the first sub-color resists are different.

3. The liquid crystal display panel according to claim 1, wherein the first color resist layer is disposed on one side of the first substrate adjacent to the polymer network liquid crystal layer, and the second color resist layer is disposed on one side of the second substrate facing away from the polymer network liquid crystal layer.

4. The liquid crystal display panel according to claim 1, wherein the first sub-color resists in the first color resist layer are arranged at intervals, and the second sub-color resists in the second color resist layer are arranged adjacently.

5. The liquid crystal display panel according to claim 4, wherein an area of the second sub-color resists is 5% to 15% greater than an area of the corresponding first sub-color resists.

6. The liquid crystal display panel according to claim 4, wherein an orthographic projection of any one of the first sub-color resists on the first substrate is within an orthographic projection area of the corresponding second sub-color resist on the first substrate.

7. The liquid crystal display panel according to claim 1, wherein the first sub-color resists comprise a plurality of first red sub-color resists, a plurality of first green sub-color resists, and a plurality of first blue sub-color resists.

8. The liquid crystal display panel according to claim 1, wherein the first sub-color resists comprise a plurality of first red sub-color resists, a plurality of first green sub-color resists, a plurality of first blue sub-color resists, and a plurality of first white sub-color resists.

9. The liquid crystal display panel according to claim 8, wherein a number of the first white sub-color resists accounts for 25% or 50% of a total number of the first sub-color resists.

10. The liquid crystal display panel according to claim 1, wherein on one side surface of the second substrate facing away from the polymer network liquid crystal layer, the second color resist layer and a protective layer are stacked in sequence.

11. The liquid crystal display panel according to claim 10, wherein the protective layer is a transparent organic polymer thin film or a silicon nitride thin film.

12. The liquid crystal display panel according to claim 1, wherein on one side of the first substrate adjacent to the polymer network liquid crystal layer, a thin film transistor layer, the first color resist layer, a pixel electrode layer, and a first alignment film are stacked in sequence.

13. The liquid crystal display panel according to claim 1, wherein on one side surface of the second substrate adjacent to the polymer network liquid crystal layer, a black matrix layer, a common electrode layer, and a second alignment film are stacked in sequence.

14. A manufacturing method of a liquid crystal display panel, comprising following steps:
S01: providing a first substrate and forming a thin film transistor layer, a first color resist layer, a pixel electrode layer, and a first alignment film on the first substrate in sequence, wherein the first color resist layer comprises a plurality of first sub-color resists;
S02: providing a second substrate and forming a second color resist layer and a protective layer on a first surface of the second substrate in sequence, wherein the second color resist layer comprises a plurality of second sub-color resists disposed correspondingly to the first sub-color resists in the first color resist layer;
S03: flipping the second substrate and forming a black matrix layer, a common electrode layer, a second alignment film, and a spacer layer on a second surface of the second substrate in sequence;
S04: aligning the first substrate to the second surface of the second substrate to form a cell; and
S05: forming a polymer network liquid crystal layer between the first substrate and the second substrate.

15. The manufacturing method of the liquid crystal display panel according to claim 14, wherein in the step S02, a step of forming the protective layer comprises forming a layer of transparent organic polymer thin film by coating or forming a layer of silicon nitride thin film by chemical vapor deposition.

16. The manufacturing method of the liquid crystal display panel according to claim 14, wherein the first sub-color resists in the first color resist layer are arranged at intervals, and the second sub-color resists in the second color resist layer are arranged adjacently.

17. The manufacturing method of the liquid crystal display panel according to claim 16, wherein an orthographic projection of any one of the first sub-color resists on the first substrate is within an orthographic projection area of the corresponding second sub-color resist on the first substrate.
